(19) United States
(12) Patent Application Publication
(10) Pub. No.: US 2005/0074577 A1
(43) Pub. Date: Apr. 7, 2005

(54) Optical recording medium

(75) Inventors: Toshihiko Takishita, Koufu-shi (JP); Kazuo Kuroda, Tokorozawa-shi (JP); Toshio Suzuki, Tokorozawa-shi (JP); Eiji Muramatsu, Tokorozawa-shi (JP); Masahiro Kato, Tokorozawa-shi (JP); Seiro Oshima, Koufu-shi (JP); Atsushi Kondo, Koufu-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/950,821

(22) Filed: Sep. 28, 2004

(30) Foreign Application Priority Data
Oct. 3, 2003 (JP) P2003-346294

(51) Int. Cl. B32B 3/02

(52) U.S. Cl. 428/64.4

(57) ABSTRACT

An optical recording medium of dual layer type is provided which has at least a first substrate, a first recording layer capable of optical recording, a translucent reflecting layer, an intermediate layer, a second recording layer capable of optical recording, and a second substrate in this order from a side where a laser beam for recording, reproduction, or recording/reproduction is applied, wherein the first recording layer is made of an organic dye and the second recording layer is made of a metal material having a higher reflectivity than the organic dye. The optical recording medium provides sufficient signal amplitudes from both recording layers during reproduction, and gives compatibility with a typical optical recording medium during reading.

### BACKGROUND OF THE INVENTION

1. Field of the Invention

The present invention relates to an optical recording medium. More particularly, the present invention relates to improvement in a recording characteristic for each recording layer in a writable optical recording medium of a double layer structure.

2. Description of the Related Art

Optical recording mediums such as a DVD (digital versatile disc) are conventionally known as recording mediums for recording and reproducing various kinds of information. The known optical recording mediums include an optical recording medium of single layer type which has a layer for recording information from one side, and an optical recording medium of dual layer type which has two layers for recording information from one side.

Of these optical recording mediums, the optical recording medium of dual layer type has two layers for recording information (the layers for recording information are hereinafter simply referred to as “recording layers”), so that a large amount of information can be recorded and reproduced with high density. Further, since the optical recording medium of dual layer type makes it possible to record information on two recording layers from one side, it is not necessary to provide optical pickups on the respective sides of the optical recording medium in a recording/reproducing apparatus for the optical recording medium, and to switch the optical pickups alternately. Moreover, the optical recording medium of dual layer type does not have to flip the optical recording medium during recording and reproduction. Thus, the optical recording medium of dual layer type enables so-called seamless recording and seamless reproduction.

As described above, the optical recording medium of dual layer type is advantageous in that it has superior functionality for recording information, a recording/reproducing apparatus can have a simple configuration, and seamless recording and reproduction do not interrupt with the user who watches videos.

Regarding such DVDs, so-called DVD-R and DVD-RAM have been already developed which enable the user to record information.

Of these DVDs, a DVD-R has a basic configuration in which a pregroove composed of a spiral groove serving as the tracking means of an optical pickup is formed in an information recording region on a surface of a disc, on which a recording medium made of a material such as an organic dye is applied by spin coating and so on, and dried to form a recording layer, and a reflecting layer composed of a metal film is formed thereon.

For example, as shown in FIG. 1, JP-11-066622-A discloses an optical recording medium 6 as a DVD-R optical recording medium of dual layer type. In the optical recording medium 6, a first disc and a second disc are bonded to each other using an adhesive 5B or the like, so that a first reflecting layer 31B and a second recording layer 22B face each other, wherein the first disc comprises a first substrate 11B, a first recording layer 21B made of an organic dye and the translucent first reflecting layer 31B, the layers 21B and 31B being formed in this order on a side having the groove of a first substrate 11B, and wherein the second disc comprises a second substrate 12B, a second reflecting layer 32B and the second recording layer 22B made of an organic dye, the layers 32B and 22B being formed in this order on a side having the groove of a second substrate 12B.

In the optical recording medium 6, a laser beam is applied from the side of the first substrate 11B so as to record any information in the recording layers 21B and 22B. Such a DVD-R optical recording medium can obtain, e.g., a relatively high reflectivity of not less than 18% to a laser beam for reproduction, thereby achieving compatibility with a DVD-ROM in the DVD reproducing apparatus.

However, as shown in FIG. 1, in the case of the DVD-R optical recording medium of the dual layer type, in which recording media made of an organic dye are used for both the first and second recording layers, the first recording layer 21B is formed in contact with the first substrate 11B on the side where a laser beam is applied, whereas the second recording layer 22B is bonded to the second substrate 12B via the second reflecting layer 32B. Thus, a groove formed on the second recording layer 22B is less likely to conform the shape of a groove formed on the second substrate 12B. Further, from the side where the laser beam is applied, the second recording layer 22B is located inside the recording medium, namely, located below the first substrate 11B, the first recording layer 21B, the translucent first reflecting layer 31B, and the adhesive layer (intermediate layer) 5B. Because of this fact, when a laser for recording or recording/reproduction is applied from the side of the first substrate 11B to the second recording layer 22B to perform recording, the second recording layer 22B has a different thermal behavior from the first recording layer 21B during the recording. Further, unlike the first recording layer, pit formation due to the thermal deformation of the substrate at the boundary surface between the recording layer and the substrate is not caused easily. Consequently, recording information in the second recording layer cannot have a sufficient signal amplitude.

### SUMMARY OF THE INVENTION

Therefore, an object of the present invention is to provide an improved optical recording medium. Another object of the present invention is to provide an optical recording medium of dual layer type whereby a recording characteristic is improved for each recording layer, particularly for a second recording layer positioned away from the side where a laser beam is applied, a sufficient signal amplitude is obtained from both recording layers during reproduction, and compatibility with the conventional optical recording medium is achieved when reading out.

A technique for solving the above mentioned problems is an optical recording medium, comprising a first substrate, a first recording layer capable of optical recording, a translucent reflecting layer, an intermediate layer, a second recording layer capable of optical recording, and a second substrate in this order from a side where a laser light for recording, reproduction, or recording/reproduction is applied, wherein the first recording layer is composed of an organic dye and the second recording layer is composed of a metal material having a higher reflectivity than the organic dye.

In an embodment of the present invention, the optical recording medium of which the second recording layer has a double layer structure composed of a first metal material layer and a second metal material layer in this order from the first substrate, and the first metal material layer is composed of a metal material having a higher reflectivity than the second metal material layer is also provided.

### BRIEF DESCRIPTION OF THE DRAWINGS

FIG. 1 is a sectional view showing an optical recording medium of the prior art; and

FIG. 2 is a sectional view showing an optical recording medium according to an embodiment of the present invention.

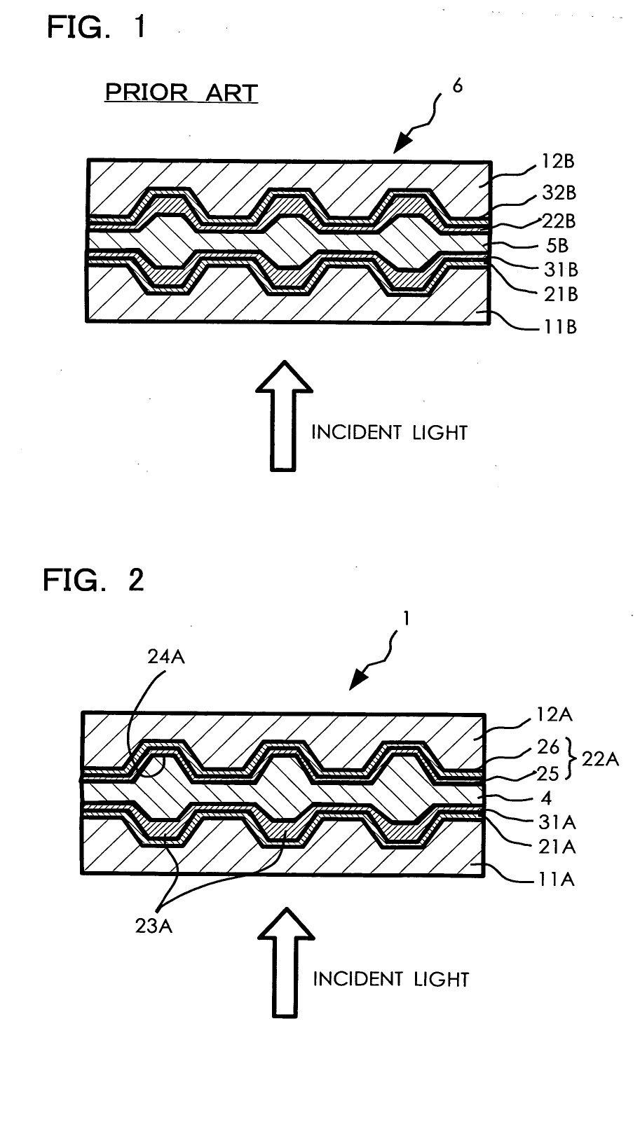

### DETAILED DESCRIPTION OF THE PREFERRED EMBODIMENTS

Now, the optical recording medium and a method of manufacturing thereof according to the present invention will be described in detail by illustrating some embodiments and with reference to the accompanying drawings. FIG. 2 is a sectional view which partially shows the optical recording medium according to an embodiment of the present invention along the thickness direction. In FIG. 2, the thicknesses of respective layers are exaggerated for purposes of illustration.

First, the configuration of the optical recording medium according to this embodiment will be described.

As shown in FIG. 2, in an optical recording medium 1 of this embodiment, a first substrate 11A, a first recording layer 21A made of an organic dye as a recording medium, a translucent reflecting layer 31A, a transparent adhesive layer (intermediate layer) 4, a second recording layer 22A made of a metal material as another recording medium, and a second substrate 12A are disposed in this order from the side where a laser beam for recording, reproduction, or recording/reproduction is applied. Further, the first recording layer 21A is formed according to the shape of a first groove 23A formed on the first substrate 11A, and the second recording layer 22A is formed according to the shape of a second groove 24A formed on the second substrate 12A.

The material of the first substrate 11A may be a highly transparent resin, e.g., a resin having a light transmittance of 80% or higher for a laser beam for recording, reproduction, or recording/reproduction. A resin with a light transmittance of 90% or higher is more preferable. To be specific, for example, a polycarbonate resin, an acrylic resin such as polymethyl methacrylate, and a polyolefin resin are utilizable. The material of the first substrate 11A, however, is not limited to these resins.

The thickness of the first substrate 11A is normally 0.1 to 0.6 mm, although it will be is determined according to the specification of the optical recording medium 1. That is, when the optical recording medium 1 is a DVD-R disc for a red laser, the first substrate 11A is 0.6 mm in thickness. When the optical recording medium 1 is a disc for a blue laser, the first substrate 11A is 0.6 mm or 0.1 mm in thickness. Besides, the first substrate 11A is a circular plate having a hole at the center.

A groove is formed on a surface of the first substrate 11A, to which surface the first recording layer 21A is formed. The groove is normally about 140 to 180 nm in depth, about 0.25 to 0.35 μm in width, and about 0.7 to 0.9 μm in pitch.

The groove is shaped like a spiral or concentric circles, taken from the surface of the first substrate 11A. Further, the groove may meander in the radius direction at predetermined intervals. Hereinafter, such a meandering groove is referred to as a wobble groove. Prepits for address information and so on may be formed at predetermined intervals on lands positioned between the grooves.

The material of the first recording layer 21A composed of an organic dye is not particularly limited as long as the material is an organic dye used for the recording layer of the conventional optical recording medium. For example, a complex of azo compound, cyanine dye, phthalocyanine dye, and so on may be usable. The first recording layer 21A normally has a thickness of 50 to 120 nm, although it is not particularly limited thereto.

The reflecting layer 31A is made of metals including gold, aluminum, silver, copper and an alloy of these metals, e.g., an Ag—Pd—Cu alloy. The material of the reflecting layer 31A is not limited to these metals. The reflecting layer 31A normally has a thickness of about 10 nm±2 nm, although is not particularly limited thereto as long as translucency is obtained, that is, a laser beam for recording, reproduction, or recording/reproduction can be passed through or reflected by the reflecting layer, according to the wavelength of the laser beam used.

As will be described later, the optical recording medium 1 of the present embodiment is manufactured by forming the first recording layer 21A and the translucent reflecting layer 31 on the side of the first substrate 11A, and the second recording layer 22A on the side of the second substrate 12A, and bonding these substrates as facing each other. Therefore, the adhesive layer (intermediate layer) 4 formed on the bonding interface of the substrates is not particularly limited as long as the adhesive is highly transparent, e.g., the adhesive has a light transmittance of 80% or higher for a laser beam for recording, reproduction, or recording/reproduction. An adhesive with a light transmittance of 90% or higher is more preferable. For example, the adhesive layer 4 can be formed using various conventional UV curing resins. As shown in FIG. 2, the second recording layer 22A facing the adhesive layer (intermediate layer) 4 is made of a metal material. Even when the optical recording medium is manufactured using such a bonding method, as in the case where the recording layer is made of an organic dye, it is not so necessary to consider the influence of a solvent component, which is contained in the adhesive to be used, on the second recording layer 22A and thus the selectivity and the applying conditions of the used adhesive are eased. Thus, it is possible to readily manufacture the optical recording medium.

The method of manufacturing the optical recording medium according to the present invention is not limited to the bonding method of the present embodiment. For example, the first recording layer, the reflecting layer, the intermediate layer, the second recording layer, and the second substrate may be laminated in this order from the first substrate 1. In this case, a groove for forming a groove on the second recording layer may be provided on the intermediate layer instead of the second substrate. In such a configuration, the material of the transparent intermediate layer is not particularly limited as long as the substantially same groove is formed as the groove formed on the first substrate. It is preferable to use a UV curing resin.

The intermediate layer 4 normally has a thickness of about 40 μm, although it is not particularly limited thereto.

The second recording layer 22A is made of a metal material. When the second recording layer 22A is made of a metal material, the transmittance of the metal material of the second recording layer 22A is irrelevant to the recording and reproduction of the optical recording medium, so that the range of choices of materials is extended and the optical recording medium is readily manufactured. With this configuration, for example, a reflectivity of 18% or higher can be obtained during reproduction and compatibility with a ROM is achieved.

The recording principle of the metal material may be drilling recording or phase change recording as long as the second recording layer 22A is changed in reflectivity from high to low during recording to achieve compatibility with a ROM. Although the metal material is not particularly limited, it is possible to use a low melting metal or a metal alloy with a high reflectivity. To be specific, Al or an Al alloy, Bi—Ge—Sn, and so on can be used. The second recording layer 22A made of these metal materials can be formed by, e.g., vacuum evaporation, sputtering, CVD, and so on.

Besides, as shown in FIG. 2, the second recording layer 22A may be composed of two layers of a first metal layer 25 and a second metal layer 26. In this case, the first metal layer 25 on the side of the first substrate (the side where a laser beam for recording, reproduction, or recording/reproduction comes to) is made of a metal material having a high reflectivity. The second metal layer 26 mainly acts as a reactive agent for oxidation-reduction reaction. For example, the first metal layer 25 may be composed of Al or an Al alloy and the second metal layer 26 may be composed of ZnO₂. Alternatively, the first metal layer 25 may be composed of Bi—Ge—Sn and the second metal layer 26 may be composed of a WO₃ layer.

The second recording layer 22A normally has a thickness of about 50 to 140 nm, although it is not particularly limited thereto. When the second recording layer 22A is composed of two layers of the first metal layer and the second metal layer, the two layers respectively have thicknesses of about 10 to 80 nm and 5 to 60 nm, although they are not particularly limited thereto.

The second substrate 12A is made of the same material with the same thickness and shape as the first substrate 11A.

The configuration of the optical recording medium 1 is not limited to the layered structure of FIG. 2. Other layers may be provided when necessary as long as the foregoing layers are provided.

For example, the optical recording medium 1 may include a dielectric layer (not shown). The dielectric layer is formed between the intermediate layer 4 and the second recording layer 22A of the optical recording medium 1. To be specific, the dielectric layer is formed along grooves formed on the intermediate layer 4. The dielectric layer is provided to protect the second recording layer 22A and adjust the optical property and thermal property of the optical recording medium 1.

The material for the dielectric layer is not particularly limited and conventionally known materials can be used. A material such as ZnS—SiO₂, SiO₂, and AlN may be used in ordinary cases. The dielectric layer normally has a thickness of about 1 to 10 nm, although it is not particularly limited thereto.

Further, in the optical recording medium 1 shown in FIG. 2, a first groove 23A of the first recording layer 21A and a second groove 24A of the second recording layer 22A are positioned in synchronization with each other (that is, overlaid on each other) in a direction orthogonal to the tracking direction. The arrangement of the first groove 23A of the first recording layer 21A and the second groove 24A of the second recording layer 22A is not limited to the arrangement of FIG. 2. The grooves may be positioned with a phase difference (that is, shifted from each other).

In the optical recording medium 1, a laser beam for recording or a laser beam for recording/reproduction is applied from the side of the first substrate 11A, and pits are formed on the first groove of the first recording layer 21A and the lands of the first groove, and the second groove of the second recording layer 22A and the lands of the second groove. Similarly, a laser beam for reproduction or a laser beam for recording/reproduction is applied from the side of the first substrate 11A, and pit information formed on the first recording layer 21A and the second recording layer 22A is read out.

As described above, the optical recording medium 1 of the present embodiment has the first substrate 11A, the first recording layer 21A made of an organic dye as a recording medium, the translucent reflecting layer 31A, the transparent adhesive layer (intermediate layer) 4, the second recording layer 22A made of a metal material as anther recording medium, and the second recording layer 22A in this order from the side where a laser beam for recording, reproduction, or recording/reproduction is applied.

Thus, according to the optical recording medium 1 of the present embodiment, when a laser beam for recording, reproduction, or recording/reproduction is applied from the side of the first substrate 11A to the recording layers 21A and 22A in the grooves 23A and 24A to perform recording therein, pits can be formed by thermal deformation of the metal material also in the second recording layer 22A and a sufficient signal amplitude can be obtained from both of the recording layers during reproduction.

The following will describe an example of a method for manufacturing the optical recording medium 1 according to the present embodiment.

According to the optical recording medium 1 of the present embodiment, a groove is formed on a predetermined position on one side of the first substrate 11A, an organic dye as a recording medium is laminated to form the first recording layer 21A on a surface where the groove of the first substrate 11A is formed, the first recording layer 21A having the first groove 23A formed according to the shape of the groove of the first substrate, and then, the reflecting layer 31A is laminated on the first recording layer 21A, so that the first disc is formed.

Meanwhile, a groove is formed on a predetermined position on one side of the second substrate 12A, and a metal material as another recording medium is laminated to form the second recording layer 22A on a surface where the groove of the second substrate 12A is formed, the second recording layer 22A having the second groove 24A formed according to the shape of the groove of the second substrate, so that the second disc is formed.

Thereafter, the first disc and the second disc are oriented to face each other while the recording layers 21A and 22A are aimed inside and the substrates 11A and 12A are aimed outside. The first and second discs are bonded to each other via an adhesive (adhesive layer 4) such as a UV curing adhesive disposed on the bonding interface, so that the optical recording medium is manufactured.

In this manufacturing method, the first substrate 11A made of the above material with the above thickness is formed by injection molding of resin with a stamper. The first groove is formed on one side of the first substrate 11A.

Subsequently, the first recording layer 21A made of the above material with the above thickness is formed on the first groove formed on the first substrate 11A. The method of forming the first recording layer 21A is not particularly limited. Spin coating or the like is used in ordinary cases. To be specific, when the first recording layer 21A is formed by spin coating, the material of the first recording layer 21A is dissolved or dispersed into a solvent to prepare coating slip, and the coating slip is spin coated onto the first substrate 11A.

When the complex of an azo compound is used as the material of the first recording layer 21A, tetrafluoropropanol, octafluoropentanol or the like may be used as the solvent of the coating slip. Further, when the cyanine dye is used as the material of the first recording layer 21A, ethyl cellosolve, dimethylcyclohexane or the like is used as the solvent of the coating slip.

Then, the first reflecting layer 31A made of the above material with the above thickness is formed on the first recording layer 21A. The method of forming the first reflecting layer 31A is not particularly limited. Sputtering, deposition, and so on may be used in ordinary cases.

The second substrate 12A made of the above material with the above thickness is formed by injection molding of resin with a stamper. The second groove is formed on one side of the second substrate 12A.

Further, onto the second groove formed on the second substrate 12A, the second recording layer 22A made of the above material with the above thickness is formed. The preparing method thereof is not particularly limited. The second recording layer 22A may be usually formed by vacuum evaporation, sputtering, CVD, and so on.

Subsequently, the first and second discs thus formed are bonded to each other while facing each other according to the above mentioned manner. The first reflecting layer 31A on the first disc and the second recording layer 22A on the second disc are bonded to each other by using, e.g., the above adhesive.

To be specific, the adhesive is applied to the surface to be bonded of the first reflecting surface 31A or the second recording layer 22A by spin coating and so on. The other surface to be bonded and not having the adhesive is overlaid on the face of applied adhesive and is subjected to press bonding. When the UV curing adhesive is used as an adhesive, the adhesive is cured by applying ultraviolet rays after the press bonding, so that the two substrates 11A and 12A are bonded to each other.

In this way, the optical recording medium 1 of the present invention is manufactured.

When the dielectric layer (not shown) is additionally provided, the dielectric layer is formed on the second recording layer 22A. The method of forming the dielectric layer is not particularly limited and conventionally known methods may be usable. Sputtering, deposition, and so on may be used in ordinary cases.

The above description explained the bonding method as an example of the method for manufacturing the optical recording medium of the present embodiment. The manufacturing method is not limited to the bonding method. The manufacturing method of stacking the layers successively in order from the first substrate is also applicable.

### EXAMPLES

The optical recording medium of the present invention will be more specifically described below with reference to examples.

### Xample 1

On a disk-shaped first substrate made of polycarbonate with a thickness of 0.6 mm, a wobble groove with a depth of 155 nm, a width of 310 nm, and a track pitch of 0.8 μm was formed in a spiral fashion as a groove, and prepits were formed at predetermined intervals on lands between the wobble grooves.

On a groove forming surface of the first substrate, coating slip prepared by dissolving and dispersing a metal organic dye, which is composed of a complex of an azo compound, into tetrafluoropropanol was applied by spin coating in order to form a first recording layer with a thickness of 60 nm. Then, on the first recording layer, an Ag—Pd—Cu alloy was formed by sputtering and a reflecting layer was formed with a thickness of 11 nm, so that a first disc was formed.

Meanwhile, on a disc-shaped second substrate made of polycarbonate with a thickness of 0.6 mm, a wobble groove with a depth of 155 nm, a width of 310 nm, and a track pitch of 0.8 μm was formed in a spiral fashion as a groove, and prepits were formed at predetermined intervals on lands between the wobble grooves.

On the groove formed surface of the second substrate, a WO₃ layer and a Bi—Ge—Sn material layer were formed by sputtering in this order with thicknesses of 20 nm and 60 nm, respectively, in order to form a second recording layer of a double layer structure, so that a second disc was formed.

Thereafter, the first disc and the second disc were oriented to face each other while the recording layers 21A and 22A were aimed inside and the substrates 11A and 12A were aimed outside. The first and second discs were bonded to each other via a UV curing adhesive applied on the bonding interface, so that the optical recording medium was manufactured.

After the writing was performed by applying a laser beam to the obtained optical recording medium, an attempt to read the recorded information by a laser beam was performed. As a result, almost the same reproduction signal characteristics were obtained between the first recording layer and the second recording layer.

### Example 2

On a disk-shaped first substrate made of polycarbonate with a thickness of 0.6 mm, a wobble groove with a depth of 155 nm, a width of 310 nm, and a track pitch of 0.8 μm was formed in a spiral fashion as a groove, and prepits were formed at predetermined intervals on lands between the wobble grooves.

On a groove forming surface of the first substrate, coating slip prepared by dissolving and dispersing a metal organic dye, which is composed of a complex of an azo compound, into tetrafluoropropanol was applied by spin coating to form a first recording layer with a thickness of 60 nm. Then, on the first recording layer, an Ag—Pd—Cu alloy was formed by sputtering to form a reflecting layer with a thickness of 11 nm, so that a first disc was formed.

Meanwhile, on a disc-shaped second substrate made of polycarbonate with a thickness of 0.6 mm, a wobble groove with a depth of 155 nm, a width of 310 nm, and a track pitch of 0.8 μm was formed in a spiral fashion as a groove, and prepits were formed at predetermined intervals on lands between the wobble grooves.

On a groove forming surface of the second substrate, a ZrO₂ layer and an Al alloy layer were formed by sputtering in this order with thicknesses of 15 nm and 30 nm, respectively, in order to form a second recording layer of a double layer structure, so that a second disc was formed.

Thereafter, the first disc and the second disc were oriented to face each other while the recording layers 21A and 22A were aimed inside and the substrates 11A and 12A were aimed outside. The first and second discs were bonded to each other via a UV curing adhesive applied on the bonding interface, so that the optical recording medium was manufactured.

After the writing was performed by applying a laser beam to the obtained optical recording medium, an attempt to read the recorded information by a laser beam was performed. As a result, almost the same reproduction signal characteristics were obtained between the first recording layer and the second recording layer.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-346294 filed on Oct. 3, 2003 including the specification, claims, drawings and summary is incorporated herein by reference in its entirety.

1. An optical recording medium, comprising:
a first substrate,
a first recording layer capable of optical recording,
a translucent reflecting layer,
an intermediate layer,
a second recording layer capable of optical recording, and
a second substrate;
in this order from a side where a laser beam for recording, reproduction, or recording/reproduction is applied,
wherein the first recording layer comprises an organic dye and the second recording layer comprises a metal material having a higher reflectivity than the organic dye.

2. The optical recording medium according to claim 1, wherein the second recording layer has a double layer structure composed of a first metal material layer and a second metal material layer in this order from the first substrate, and the first metal material layer comprises a metal material having a higher reflectivity than the second metal material layer.
